(19) United States
(12) Patent Application Publication
(10) Pub. No.: US 2008/0149655 A1
(43) Pub. Date: Jun. 26, 2008

(54) Variable capacity refrigeration system

(75) Inventors: David B. Gist, Grayslake, IL (US); Gregory M. Billman, Hoffman Estates, IL (US); Santhosh Kumar, Woodridge, IL (US); Kyle B. Elsom, Batavia, IL (US); Nikolay Popov, Warrenville, IL (US); Daniel C. Leaver, Westmont, IL (US)

Correspondence Address: PYLE & PIONTEK LLC, 221 N. LASALLE STREET, SUITE 2036, CHICAGO, IL, 60601, US

(73) Assignee: IMI Cornelius Inc.

(21) Appl. No.: 11/974,061

(22) Filed: Oct. 11, 2007

Related U.S. Application Data
(60) Provisional application No. 60/851,033, filed on Oct. 11, 2006.

(51) Int. Cl. G07F 11/62; G07F 9/10; F25B 41/04

(52) U.S. Cl. 221/1; 221/150 R; 62/222; 221/2

(57) ABSTRACT

A variable capacity refrigeration system for a frozen product dispenser is controllable in response to cooling load requirements of the dispenser to have a variable cooling capacity that is in accordance with the cooling load demands placed on the refrigeration system by the dispenser. This is accomplished, in part, by providing the refrigeration system with a variable capacity compressor, the output capacity of which is controlled by varying its operating speed in a manner such that refrigerant output from the compressor generally meets the mass flow of refrigerant through expansion valves of the system. The arrangement provides for efficient operation of the frozen product dispenser from an energy standpoint and for a reduction in on/off cycling of the refrigeration system.

This application claims benefit of provisional application Ser. No. 60/851,033, filed Oct. 11, 2006.

### FIELD OF THE INVENTION

The present invention relates to refrigeration systems, and in particular to a variable capacity refrigeration system for efficiently handling large variations in cooling load requirements of a frozen beverage product dispenser.

### BACKGROUND OF THE INVENTION

Cooling load requirements of frozen beverage product dispensers are highly variable. Customer demand for beverages can vary from no drinks dispensed per minute to as many as 3 or 4 or more drinks served per minute. This volatile variation in customer demand results in a very broad range in cooling load requirements for a refrigeration system of a typical frozen product dispenser, for example as is shown by the chart of FIG. 9. As can be seen, depending upon ambient temperature and during periods when no product is being drawn, the maintenance cooling load of a frozen product dispenser can be as low as about 1500 Btu/hr. At the other extreme and during periods of high drink draw rates, for example when delivering drinks at the rate of 4×16 oz drinks per minute, cooling load requirements of a frozen product dispenser may be in excess of 18,000 Btu/hr. This represents about a 12:1 turndown ratio, which from an energy standpoint conventional refrigeration systems are not able to efficiently accommodate.

As is known, refrigeration systems of conventional frozen product dispensers utilize a compressor that delivers refrigerant through a condenser to one or more expansion valves, each of which controls delivery of refrigerant to an associated evaporator cooling coil that is thermally coupled to an associated beverage product freeze barrel in order to chill the barrel and at least partially freeze beverage product in the barrel. To accommodate various cooling load requirements of the barrels, the expansion valves may be variably controlled. As load requirements of an evaporator coil change due to changing customer demands, the expansion valve supplying refrigerant to the evaporator changes to a more appropriate flow metering position. The objective is to adjust the expansion valve so as to match the cooling capability of the evaporator, based upon refrigerant flow to the evaporator, more closely to the dynamically changing cooling load requirements of the barrel being chilled by the evaporator. However, fixed speed compressors of a type normally used for frozen product dispensers are not readily able to accommodate changes in cooling load requirements, and are best suited to providing refrigerant flow at a certain rate, despite changes in the cooling load. Refrigeration system balance therefore becomes disturbed as the expansion valves are adjusted to meet changing cooling load requirements, resulting in saturated evaporator temperatures dropping as cooling load requirements decrease, rising as cooling load requirements increase, and poor control over the temperature of the evaporator. In addition, when cooling load requirements decrease, cooling of beverage product in the barrel is quickly satisfied and the compressor must be frequently cycled off/on, resulting in increased stress of compressor components. In consequence, where the compressor is not matched with the cooling load, during periods of low product demand the compressor will cycle on/off excessively and the system will operate less efficiently and use more energy than would otherwise be required.

### OBJECT OF THE INVENTION

An object of the present invention is to provide a variable capacity refrigeration system for a frozen product dispenser, which utilizes a variable capacity compressor that is operated at speeds selected to provide the refrigeration system with a cooling capacity that closely matches a cooling load demand of the dispenser.

Another object is to provide a variable capacity refrigeration system for a frozen product dispenser, in which expansion valves for evaporators for freeze barrels are controlled to meter refrigerant to the evaporators in accordance with the cooling load requirements of the freeze barrels, and in which the variable capacity compressor is operated at a speed to provide at its outlet a refrigerant mass flow commensurate with that being metered through the expansion valves.

### SUMMARY OF THE INVENTION

In accordance with the present invention, a frozen product dispenser comprises at least one product freeze barrel for freezing liquid product introduced therein; means for dispensing frozen product from the freeze barrel; means for introducing liquid product into the at least one freeze barrel as a function of dispensing frozen product from the at least one freeze barrel; a refrigeration system for chilling the at least one freeze barrel to freeze liquid product in the at least one freeze barrel; and means for controlling the refrigeration system to have a variable cooling capacity in accordance with a heat load placed on the refrigeration system by the frozen product dispenser, whereby the refrigeration system efficiently responds to large variations in cooling load requirements of the frozen product dispenser.

The invention also provides a method of making a frozen product using a frozen product dispenser having at least one freeze barrel, which method comprises the steps of using a refrigeration system to chill the at least one freeze barrel to freeze liquid product therein; dispensing frozen product from the at least one freeze barrel; introducing liquid product into at least one freeze barrel as a function of dispensing frozen beverage product from the at least one freeze barrel; and controlling the refrigeration system to have a variable cooling capacity in accordance with a heat load placed on the refrigeration system by the frozen product dispenser, whereby the refrigeration system efficiently responds to large variations in cooling load requirements of the frozen product dispenser.

### BRIEF DESCRIPTION OF THE DRAWINGS

FIG. 1 is a schematic representation of one embodiment of variable capacity refrigeration system according to the invention, which is adapted for use in a frozen product dispenser for chilling two product freeze barrels and a product pre-chiller of the dispenser;

FIG. 2 is a schematic representation of another embodiment of variable capacity refrigeration system that is similar to the system of FIG. 1, except that it does not include a product pre-chiller;

FIG. 3 is a schematic representation of a frozen product dispensing system utilizing ambient temperature carbonation, of a type with which a variable capacity refrigeration system of the invention may be used;

FIG. 4 is a schematic representation of a frozen product dispensing system utilizing chilled carbonation, of another type with which a variable capacity refrigeration system may be used;

FIG. 5 is a schematic representation of a frozen product dispensing system utilizing an in-line chilled carbonation system, of a further type with which a variable capacity refrigeration system may be used;

FIG. 6 is a control strategy and function table, showing a contemplated manner of operation of the variable capacity refrigeration system of FIG. 1;

FIG. 7 is a table showing a contemplated manner of operation of the variable capacity refrigeration system of FIG. 1 during pull-down of a frozen product dispenser;

FIG. 8 is a table showing a contemplated manner of operation of the variable capacity refrigeration system FIG. 1 in pre-chilling a product mixture flowing to the barrels of a frozen product dispenser;

FIG. 9 is a chart showing typical cooling load requirements for a frozen carbonated beverage (FCB) dispenser for various product draw rates and ambient temperatures;

FIG. 10 is a chart showing cooling load requirements for an FCB dispenser at an ambient temperature of 75° F. for various product draw rates in each of the three conditions of maintaining, pre-chilling and freezing beverage product;

FIG. 11 is a chart showing cooling load requirements for an FCB dispenser at an ambient temperature of 90° F. for various product draw rates in each of the three conditions of maintaining, pre-chilling and freezing beverage product;

FIG. 12 is a table showing, for a typical FCB dispenser, the speed of operation of a compressor of the variable capacity refrigeration system of FIG. 1, as a function of the cooling load requirements of the FCB dispenser;

FIG. 13 is a graph showing the speed of operation of the variable capacity refrigeration system compressor, as a function of the cooling load requirements of a typical FCB dispenser, and

FIGS. 14A and 14B show a microprocessor control for controlling an FCB dispenser in accordance with the invention.

### DETAILED DESCRIPTION

The invention discloses a novel refrigeration system for efficiently providing a wide range of cooling capacities that closely match a wide range of cooling load requirements placed on the system. To efficiently provide various cooling capacities, the refrigeration system utilizes a variable capacity compressor that is driven at various speeds selected in accordance with the cooling load placed on the refrigeration system, in such manner that the refrigeration system is able to efficiently meet and closely match dynamically changing cooling load requirements. While it will be appreciated from the foregoing detailed description that the refrigeration system may be used in various diverse applications where dynamically changing cooling load requirements are encountered, a presently contemplated use for the refrigeration system is in cooling beverage product freeze barrels of a frozen carbonated beverage (FCB) dispenser, and it will therefore be described in that environment.

Ideally, a refrigeration system must efficiently handle a broad range of cooling loads imposed upon it by an FCB dispenser with which it is used in order that the dispenser might maintain good control over frozen product temperature and viscosity. Unlike conventional refrigeration systems for FCB dispensers, which normally use a fixed speed compressor that runs and pumps refrigerant at a relatively constant rate and is sized for a maximum load situation, in the refrigeration system of the invention the pumping rate of a compressor, and therefore the capacity of the compressor, is variable and closely matched to the cooling load to be met by the refrigeration system at any point in real time. The pumping rate of the compressor is decreased when cooling loads decrease, and increased when cooling loads increase, in a manner to maintain high refrigeration system efficiency. It is contemplated that the refrigeration system use a variable speed compressor having, preferably but not necessarily, a speed range on the order of at least 3:1, which can provide the ability to efficiently match compressor cooling capacity with cooling load requirements over a fairly broad range. It also is contemplated that the speed range for the compressor be on the order of about 50% nominal speed at minimum cooling capacity, to as much as 150% nominal speed at maximum cooling capacity. As a result, the need for the compressor to cycle off/on is significantly reduced, which significantly reduces the frequency of startup stresses on the compressor.

Some of the benefits achieved in use of the refrigeration system include: improvements in refrigeration cycle and energy efficiency because of a better matching of compressor pumping rate to cooling load; improvements in the reliability of the compressor; improvements in the consistency of the temperature and viscosity of finished frozen beverage product inside a barrel of an FCB dispenser; a reduction in the noise levels of the refrigeration system, since the compressor will often run at lower speeds; and a further decrease in operating noise as a result of a reduction in condenser fan speed as compressor speed is reduced.

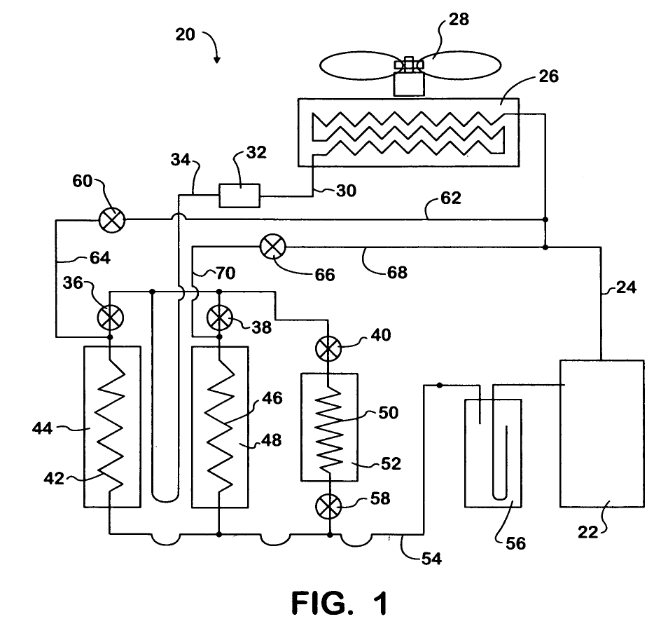

Referring to the drawings, a refrigeration system embodying the teachings of the invention is shown in FIG. 1 and indicated generally at 20. The refrigeration system includes a variable speed/capacity compressor 22, which may be a scroll or a reciprocating compressor that has a variable-frequency drive for applying to an ac motor (neither shown) of the compressor an ac voltage signal that is controlled to have a frequency selected to provide a desired speed of operation of the motor and, thereby, a desired output capacity of the compressor. Hot refrigerant at an outlet from the compressor is coupled through a refrigerant line 24 to an inlet to a condenser 26, through which air is drawn by a fan 28 to cool the refrigerant. Cooled refrigerant at an outlet from the condenser flows through a refrigerant line 30 to and through a filter/dryer 32 and a refrigerant line 34 to inlets to each of three electronically controlled expansion valves 36, 38 and 40. Refrigerant exiting an outlet from the expansion valve 36 is delivered to an inlet to an evaporator coil 42 that is heat transfer coupled to a first beverage product freeze barrel 44 of an FCB dispenser to chill the barrel and freeze beverage product in the barrel. Refrigerant exiting an outlet from the expansion valve 38 is delivered to an inlet to an evaporator coil 46 that is heat transfer coupled to a second beverage product freeze barrel 48 of the FCB dispenser to chill the barrel and freeze beverage product in the barrel. Refrigerant exiting an outlet from the expansion valve 40 is delivered to an inlet to an evaporator coil 50 that is heat transfer coupled to a pre-chiller 52 of the FCB dispenser to chill the pre-cooler and, thereby, to chill beverage product that is flowed through the pre-chiller before being introduced into the barrels 44 and 48. After passing through each of the barrel evaporators 42 and 46, refrigerant exiting outlets from the evaporators flows through a refrigerant line 54 and an accumulator 56 for return to an inlet to the compressor 22. After passing through the pre-cooler evaporator 50, refrigerant exiting the evaporator flows through an evaporator pressure regulating valve 58 and then through the refrigerant line 54 and accumulator 56 for return to the inlet to the compressor. The evaporator pressure regulating valve 58 at the outlet from the pre-cooler evaporator 50 serves as a regulator to prevent the pressure of refrigerant in the evaporator from falling below a lower limit, thereby to prevent freezing of beverage product in the pre-cooler 52.

The refrigeration system 20 has two defrost circuits, a first one of which includes a solenoid operated refrigerant valve 60 having an inlet coupled through a refrigerant line 62 to hot refrigerant at the outlet from the compressor 22 and an outlet coupled through a refrigerant line 64 to the inlet to the freeze barrel evaporator 42. A second defrost circuit includes a solenoid operated refrigerant valve 66 having an inlet coupled through a refrigerant line 68 to hot refrigerant at the outlet from the compressor and an outlet coupled through a refrigerant line 70 to the inlet to the freeze barrel evaporator 46. The defrost circuits may be operated to heat the evaporators 42 and 46 to defrost the beverage product barrels 44 and 48 in defrost cycles of the refrigeration system.

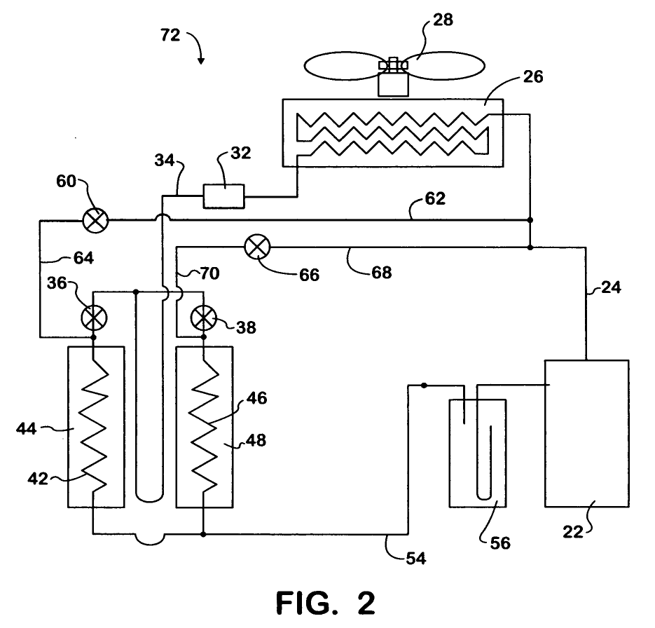

The refrigeration system 20 is adapted for use with FCB dispensers that have both beverage product freeze barrels and pre-chillers. To provide chilling for FCB dispensers that do not have pre-chillers, a refrigeration system of a type shown in FIG. 2 and indicated generally at 72 may be used. The refrigeration system 72 is similar to the FIG. 1 refrigeration system 20, and like reference numerals have been used to denote like components. A difference between the two refrigeration systems is that the refrigeration system 72 does not include a pre-chiller 52 and its associated evaporator coil 50, electronically controlled expansion valve 40 and evaporator pressure regulating valve 58. Otherwise, the two refrigeration systems 20 and 72 are the same and their operation in chilling the product freeze barrels 44 and 48 is generally similar.

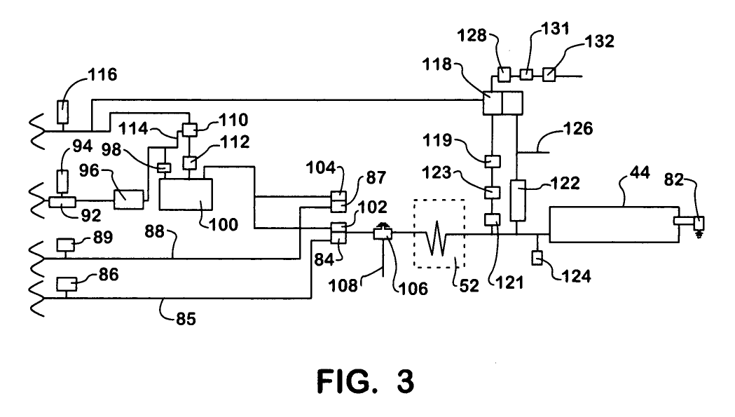

Since operation of an FCB dispenser having a pre-chiller generally embodies operation of an FCB dispenser that does not have a pre-chiller, the invention will be described in terms of the refrigeration system 20 being used with FCB dispensers having both product freeze barrels and pre-chillers. One such FCB dispenser is shown in FIG. 3 and indicated generally at 80, and includes the two beverage product freeze barrels 44 and 48, only the barrel 44 being shown. The FCB dispenser 80 utilizes ambient temperature carbonation, and while not specifically shown, it is understood that the evaporator coil 42 is heat transfer coupled to the barrel 44 to chill the barrel in order to freeze a beverage product mixture flowed into the barrel. With reference to the portion of the FCB dispenser 80 shown and associated with the freeze barrel 44, it being understood that a like description would apply to a similar but less than fully shown portion of the dispenser associated with the freeze barrel 48, a frozen beverage product dispensing valve 82 is coupled to the barrel 44 for service of frozen beverages from the barrel to customers. To deliver liquid beverage components to the barrel 44 for being frozen within the barrel, an externally pumped beverage syrup concentrate is delivered to an inlet to a syrup brixing valve 84 through a syrup line 85 to which is coupled a sensor 86 for detecting a syrup-out condition. To deliver liquid beverage components to the barrel 48 (not shown) for being frozen therein, an externally pumped beverage syrup concentrate is delivered to an inlet to a syrup brixing valve 87 through a syrup line 88 to which is coupled a sensor 89 for detecting a syrup-out condition. A potable water supply, such as from a city main, is connected to the dispenser through a strainer/pressure regulator 92, to which is coupled a pressure switch 94 for detecting a water-out condition, and from the strainer/pressure regulator the water passes through a carbonator pump 96 and a check valve 98 to a water refill inlet to a carbonator 100. The carbonator operates in a manner well understood in the art to carbonate water introduced therein, and carbonated water at an outlet from the carbonator is delivered to an inlet to a water brixing valve 102 associated with the syrup brixing valve 84 and to an inlet to a water brixing valve 104 associated with the syrup brixing valve 87. The brixing valves 104, 87 comprise an associated pair of brixing valves that deliver a water and syrup mixture in a selected ratio through an associated fluid circuit (not shown) and the pre-chiller 52 to the freeze barrel 48, and the brixing valves 102, 84 comprise an associated pair of brixing valves that deliver a water and syrup mixture in a selected ratio through an associated fluid circuit and the pre-chiller 52 to the freeze barrel 44. The beverage mixture provided at an outlet from each pair of brixing valves is in a ratio determined by the settings of the individual valves of the pair. The water and syrup mixture delivered from the brixing valves 102, 84 is delivered through a 3-way valve 106 and the pre-chiller 52 to the beverage product freeze cylinder or barrel 44, it being understood that, although not shown in FIG. 3, the evaporator coil 50 is heat exchange coupled to the pre-chiller and the evaporator coil 42 is heat exchange coupled to the freeze barrel 44. The 3-way valve 106 has an outlet 108 leading to atmosphere, by means of which a sample of the water and syrup mixture output by the bribing valves 102, 84 may be collected for analysis, such as by a refractometer reading, so that any necessary adjustments may be made to the brixing valves to provide a desired water/syrup ratio.

To carbonate water in the carbonator tank 100, an externally regulated supply of CO₂ is coupled through a temperature compensated pressure regulator 110 and a check valve 112 to the carbonator, the regulator 110 including a capillary sensor 114 for detecting the temperature of incoming water and adjusting the regulator in accordance therewith. A sensor 116 detects a CO₂-out condition, and the supply of CO₂ also is coupled to inlets to each of two CO₂ pressure regulators of a manifold 118. An outlet from a first one of the manifold CO₂ pressure regulators is coupled through a solenoid shut-off valve 119, a CO₂ flow control valve 123 and a CO₂ check valve 121 to the water and syrup mixture line extending between the pre-chiller 52 and an inlet to the freeze barrel 44. In addition, CO₂ at an outlet from the manifold second CO₂ pressure regulator is coupled to an upper opening to an expansion tank 122, a lower opening to which is coupled to the water and syrup mixture line between the pre-chiller and freeze barrel. The flow control valve 123 accommodates adjustment of the carbonation level in the barrel 44 by enabling the introduction of CO₂ into the barrel for a brief period before a mixture of water and syrup is delivered into the barrel. As is understood by those skilled in the art, when a pressure transducer 124 coupled to an inlet to the barrel 44 detects a lower cut-in pressure in the barrel, for example 20 psi, the pair of brixing valves 102, 84 is opened for flow of a water and syrup mixture into the barrel, until the pressure transducer detects an upper cut-out pressure in the barrel, for example 29 psi, whereupon the pair of brixing valves is closed. During flow of the water and syrup mixture to the barrel, the mixture is cooled as it flows through an associated circuit in the pre-chiller 52. As the water and syrup mixture freezes in the barrel 44, it expands and backs up into the expansion chamber 122.

As mentioned, the dispenser 80 includes the freeze barrel 48 and, therefore, includes further structure (not shown) that is generally duplicative of that to the right of the pair of water and syrup brixing valves 102, 84 and that accommodates delivery of a water and syrup mixture from the brixing valves 104, 87 to the barrel 48, except that the beverage mixture does not flow through a separate pre-chiller, but instead flows through an associated beverage circuit of the pre-chiller 52. In addition, a line 126 delivers CO₂ to an upper opening to an expansion chamber (not shown) for the barrel 48, a lower opening from which couples to an inlet to the barrel, and to accommodate addition of CO₂ to the barrel 48, the outlet from the first CO₂ pressure regulator of the manifold 118 is coupled through a solenoid shut-off valve 128, a CO₂ flow control valve 133 and a CO₂ check valve 132 to the inlet to the barrel.

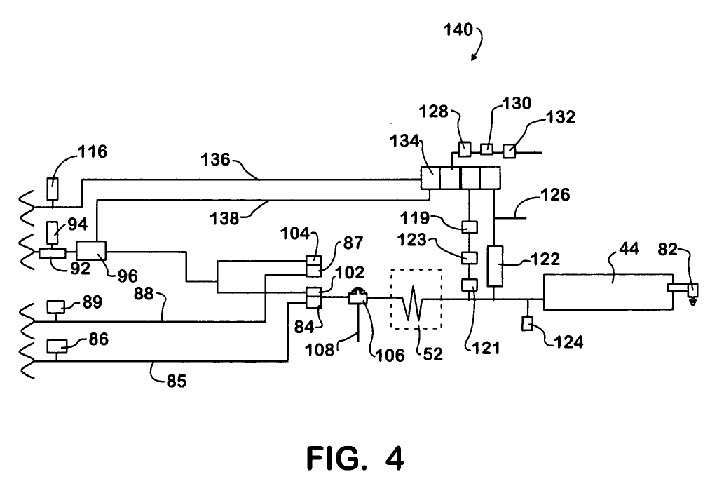

Another type of FCB dispenser with which the refrigeration system 20 may be used is shown in FIG. 4 and indicated generally at 140. The dispenser 140 is somewhat similar to the dispenser 80 of FIG. 3, except that it utilizes chilled carbonation, and like reference numerals have been used to denote like components. With reference to the portion of the FCB dispenser 140 associated with the freeze barrel 44, it being understood that a similar description would apply to a similar but only partially shown structure of the dispenser associated with the freeze barrel 48, the frozen beverage product dispensing valve 82 is coupled to the barrel 44 for service of frozen beverages to customers. To deliver liquid beverage components to the barrel 44 for being frozen in the barrel, an externally pumped beverage syrup concentrate is delivered to the syrup brixing valve 84 through the syrup line 85 to which is coupled the sensor 86 that detects a syrup-out condition, and to deliver beverage components to the barrel 48, an externally pumped beverage syrup concentrate is delivered to the inlet to the syrup brixing valve 87 through the syrup line 88 to which is coupled the sensor 89 for detecting a syrup-out condition. A potable water supply connects to the dispenser through a strainer/pressure regulator 92 to which is coupled a pressure switch 94 for detecting a water-out condition. The outlet from the strainer/pressure regulator 92 is coupled to an inlet to a CO₂ driven water pump 96. Unlike the FCB dispenser 80 of FIG. 3, in which the outlet from the water pump is connected to an inlet to an ambient temperature carbonator 100, in the FCB dispenser 140 an outlet from the water pump 96 is fluid coupled directly to the inlet to each of the water brixing valve 102 associated with the syrup valve 84 and the water brixing valve 104 associated with the syrup valve 87. The brixing valves 104, 87 deliver a water/syrup mixture in a selected ratio, determined by the settings of the valves, through an associated fluid circuit (not shown) that includes the pre-chiller 52 to the freeze barrel 48, and the brixing valves 102, 84 deliver a water/syrup mixture in a selected ratio, determined by the settings of the valves, through the pre-chiller 52 to an inlet to the freeze barrel 44. The water/syrup mixture delivered from the brixing valves 102, 84 flows through the 3-way valve 106 and the pre-chiller 52 to the inlet to the barrel 44, the outlet 108 from the valve 106 providing the means by which a sample of the water/syrup mixture may be collected for analysis.

An externally regulated supply of CO₂ is coupled to inlets to each of four CO₂ pressure regulators of a manifold 134 through a line 136, to which is coupled the sensor 116 for detecting a CO₂-out condition. An outlet from a first one of the manifold pressure regulators is coupled through a line 138 to the CO₂ driven water pump 96 to operate the pump. An outlet from a second one of the manifold CO₂ pressure regulators is coupled through the solenoid shut-off valve 119, the CO₂ orifice 120 and the CO₂ check valve 121 to the chilled water/syrup mixture flowing from the pre-chiller 52 to the inlet to the freeze barrel 44, thereby to selectively carbonate the chilled beverage mixture in accordance with the solenoid shut-off valve 119 being open or closed and the setting of the manifold second CO₂ pressure regulator, whereby either carbonated or non-carbonated beverages may selectively be frozen in the barrel 44. An outlet from a third one of the manifold CO₂ pressure regulators is coupled to the upper opening to the expansion tank 122, the lower opening to which is coupled to the water/syrup mixture line extending between the outlet from the pre-chiller 52 and inlet to the freeze barrel 44. For service of frozen carbonated beverages, the manifold second CO₂ pressure regulator accommodates adjustment of the carbonation level in the barrel 44 by controlling the introduction of CO₂ into the barrel for a brief period before a mixture of water and syrup is delivered into the barrel. The pressure transducer 124 monitors the pressure of the beverage mixture in the barrel. As is understood by those skilled in the art, when the pressure transducer detects a selected lower cut-in pressure in the barrel 44, for example 23 psi, the brixing valves 102, 84 are opened for delivery of a water/syrup beverage mixture into the barrel until the pressure transducer detects an upper cut-out pressure in the barrel, for example 29 psi, in response to which the brixing valves are closed. As the water and syrup mixture freezes in the barrel 44, it expands and backs up into the expansion chamber 122.

As the dispenser 140 includes the freeze barrel 48, it also includes further structure (not shown) that is generally duplicative of the structure shown to the right of the pair of water and syrup brixing valves 102, 84, which accommodates delivery of a water and syrup mixture from the brixing valves 104, 87 to the barrel 48, except that the beverage mixture does not flow through a separate pre-chiller, but instead flows through an associated beverage circuit of the pre-chiller 52. In addition, the line 126 at the output from the manifold third CO₂ pressure regulator delivers CO₂ to an upper opening to an expansion chamber (not shown) for the barrel 48, a lower opening from which is coupled to the inlet to the barrel, and to accommodate carbonating the beverage mixture delivered to the barrel 48, the outlet from a fourth CO₂ pressure regulator of the manifold 118 is coupled through the solenoid shut-off valve 128, the CO₂ orifice 130 and the CO₂ check valve 132 to the chilled beverage mixture intermediate the pre-chiller 52 and the inlet to the barrel.

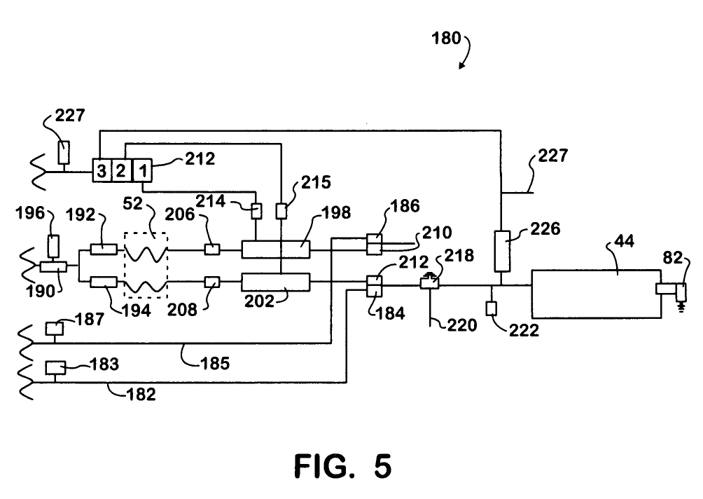

A further type of FCB dispenser with which the refrigeration system 20 may be used, and which utilizes cold carbonation, is illustrated in FIG. 5 and indicated generally at 180. In this embodiment, the FCB dispenser provides pre-chilling for an in-line carbonation system. This dispenser embodies the product freeze barrel 44 that is chilled by the evaporator coil 42 (not shown), and the frozen product dispensing valve 82 is coupled to the barrel. As for the previously described embodiments, it is understood that only somewhat more than one-half of the dispenser is illustrated and that an additional portion, which would include the product freeze barrel 48 and its evaporator 46, is not shown but is part of the dispenser 180. To deliver syrups to the dispenser, an externally pumped first flavor syrup supply (not shown) is coupled through a line 182 to an inlet to a syrup brix valve 184, with a switch 182 detecting a syrup-out condition, and an externally pumped second flavor syrup supply (not shown) is coupled through a line 185 to an inlet to a syrup brix valve 186, with a switch 187 detecting a syrup-out condition. To deliver water to the dispenser, potable water from a water main is coupled through a strainer/regulator 190 to inlets to each of two water pumps 192 and 194, and a pressure switch 196 is coupled to the strainer/regulator to sense a water-out condition. Water at outlets from the pumps 192 and 194 is flowed through associated fluid circuits in the pre-chiller 52 for being cooled, with water from the pump 192 then being delivered through a check valve 206 to a water inlet to a CO₂ turbulator 198, which is an in-line carbonation device, and then from an outlet from the turbulator to an inlet to a water brix valve 210 associated with the syrup brix valve 186. In turn, water from the pump 194 is delivered through a check valve 208 to a water inlet to a CO₂ turbulator 202, and then from an outlet from the turbulator to an inlet to a water brix valve 212 associated with the syrup brix valve 184. To carbonate water in the turbulators 198 and 202, an external supply of CO₂ is coupled through a first CO₂ pressure regulator of a manifold 212 and a check valve 214 to a CO₂ inlet to the turbulator 198, and through a second CO₂ pressure regulator of the manifold and a check valve 215 to a CO₂ inlet to the turbulator 202.

Each pair of water/syrup brix valves 210, 186 and 212, 184 is adjustable to provide a selected water/syrup ratio to its associated freeze barrel 44 and 48. A common outlet from the valves 212, 184 is coupled through a 3-way valve 218 to a beverage mixture inlet to the freeze barrel 44. The valve 218 has an outlet 220 leading to ambient, whereby a water and syrup beverage mixture supplied by the brix valves 212, 184 may be collected for analysis of its water/syrup ratio, for example by means of a refractometer reading, so that any necessary adjustments can be made to the valves 212, 184 to provide a desired ratio. A pressure transducer 222 senses the pressure of the beverage mixture in the product freeze barrel 44, and CO₂ from the external supply is delivered through a third CO₂ pressure regulator of the manifold 212 to an upper opening to an expansion tank 226, a lower opening to which is fluid coupled to the water and syrup beverage mixture in the line between the valve 218 and the inlet to the freeze barrel 44, and a sensor 227 detects a CO₂ out condition. CO₂ from the manifold third pressure regulator is also delivered through a line 227 to an upper opening of an expansion chamber (not shown) associated with the freeze barrel 48.

Since the dispenser 180 includes the freeze barrel 48 (not shown), a common outlet from its associated pair of water/syrup brixing valves 210, 186 is delivered through an associated sway valve (also not shown) to a beverage mixture inlet to the freeze barrel 48, and a pressure transducer and an expansion tank are coupled to the inlet to the freeze barrel (neither shown). Operation of the dispenser 180 in providing frozen beverage product from the freeze barrels 44 and 48 is understood by those skilled in the art, particularly in view of the above-described manner of operation of the dispensers 80 and 140.

One contemplated control strategy for operating the refrigeration system 20 to efficiently respond to dynamically changing broad ranges of cooling load requirements of an FCB dispenser will now be considered in connection with the FCB dispenser 80 of FIG. 3, it being understood that a similar control strategy would apply to use of the refrigeration system to provide cooling for other FCB dispensers, such as the FIGS. 4 and 5 dispensers 140 and 180. In general, if there is a demand for cooling and the refrigeration system compressor 22 is off at the time, the compressor is turned on and refrigerant is metered through one or more of the electronically controlled expansion valves 36, 38 and 40 at a rate commensurate with the cooling load requirements of the associated freeze barrels 44 and 48 and pre-chiller 52, with the compressor being operated at a speed selected such that the compressor provides at its outlet a refrigerant mass flow commensurate with that being metered through the expansion valves. If at the time of a demand for cooling the compressor is already running to satisfy a cooling requirement, refrigerant is metered through the expansion valves 36, 38 and/or 40 commensurate with the then existent cooling load requirements of the freeze barrels and pre-chiller, and the speed of operation of the compressor is adjusted accordingly. If neither pair of the water and syrup brix valves 102, 84 and 104, 87 is actuated to provide beverage mixture to its associated freeze barrel 44 and 48, it is assumed that beverage product draw rates, and therefore beverage product cooling load requirements, are low, and that only a maintenance cooling load need be satisfied, under which condition the compressor 22 is brought to a low running speed equal to about 50% of its nominal speed, by application of a 30 Hz AC voltage to the compressor motor. Ideally, the cooling output of the refrigeration system 20, which is based upon and in accordance with refrigerant flow from the compressor and through the expansion valves 36, 38 and 40 to the evaporators 42, 46 and 50, is closely matched to the dynamically changing cooling load requirements of the FCB dispenser 80.

To develop an indication of customer demand for frozen beverages and, therefore, an indication of the cooling load demand of the freeze barrels 44 and 48 and pre-chiller 52, so that the cooling capacity of the refrigeration system 20 might be adjusted to match to the cooling load requirements of the FCB dispenser 80, it is contemplated that the time and frequency of actuation and opening of the pairs of brix valves 108, 84 and 106, 86 be monitored. For each drink drawn, there is a batch of cooling, in terms of Btu's, that must be provided by the refrigeration system to the dispenser to chill and freeze replacement beverage product delivered by the brixing valves, and as multiple drinks are drawn, the batches multiply. Since the flow rate of water and syrup through the brixing valves can be closely approximated, the number of batches of warm beverage product delivered by the brixing valves to the freeze barrels can be correlated with the on-time of the brixing valves, which in turn relates to the cooling load that must be met by the refrigeration system. The cooling load, in terms of Btu's required to chill and freeze each batch of warm beverage product flowed from the brixing valves, can be calculated and is based upon two factors: 1) the size of the batch, which is directly related to on-time of the brixing valves, and 2) the ambient temperature of the water and syrup delivered by the brixing valves. With brixing valve on-time being monitored, a controller for the FCB dispenser counts Btu's required to be provided by the refrigeration system to the dispenser. As new and warm beverage product is delivered by the brixing valves, a Btuₜₒₜₐₗ counter of the controller is updated and incremented on a second by second basis. During times when no new product flows from the brixing valves, as the refrigeration system extracts heat from the beverage product, the Btuₜₒₜₐₗ counter is decremented over a selected period of time that may be, for example, on the order of 40 seconds. Consequently, if no new product flows from the brixing valves for the selected cooling cycle time, the total number of Btu's accumulated in the Btuₜₒₜₐₗ counter will decrement to zero and the cooling requirement of the refrigeration system will be dose to ending. However, decrementing the Btuₜₒₜₐₗ counter to zero is not determinative to turning off the refrigeration system, and the final factor that shuts off the refrigeration system is the measured viscosity of the frozen beverage product, which may be determined as a function of the current draw of motors for the freeze barrel scrapers.

The count in the Btuₜₒₜₐₗ counter is indicative of the cooling load demand being placed on the refrigeration system 20 by the FCB dispenser 80. Should the count be incrementing, which indicates that cooling load requirements are increasing, then an increase in compressor speed and expansion valve metering rate is required in order to increase the Btu output capacity of the refrigeration system to more closely match dispenser cooling load requirements. In this case, the speed of operation of the compressor may initially be incremented by 10% of its present speed, such that if the compressor is operating at 50% nominal speed, the frequency of the AC voltage applied to the compressor motor is increased by 10% to increment compressor speed to 55% nominal speed. Only during pull-down, as will be described below, when the FCB dispenser is initially turned on, will the increment in compressor speed be more aggressive, for example on the order of 50% to 60% every 5 seconds.

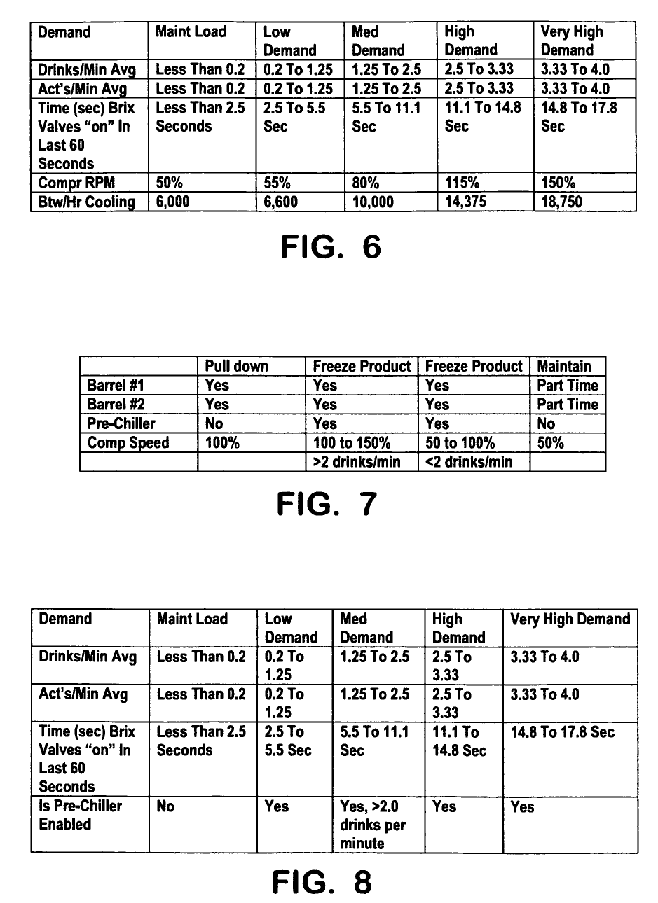

The table of FIG. 6 shows one contemplated strategy for controlling the Btu cooling capacity of the refrigeration system 20 in accordance with the count and the direction and rate of change of the count in the Btuₜₒₜₐₗ counter, under the circumstance where the FCB dispenser is in its normal mode of operation. As is seen, based upon the average number of drinks served per minute, the average number of actuations per minute of the pairs of brixing valves 102, 84 and 1104,87, and the time that the brixing valves are on or open during the last minute, the speed of operation of the compressor 22 is controlled to provide a variable capacity Btu cooling output by the refrigeration system in accordance with whether the refrigeration system is to meet a maintenance, low, medium, high or very high cooling load of the FCB dispenser.

Pull-down mode occurs when the FCB dispenser is first turned on after being off, such that the freeze barrels 44 and 48 are warm. Under this circumstance, the refrigeration system 20 is controlled to quickly drop the temperatures of the freeze barrels, the objective being to rapidly bring product in the barrels to within predetermined temperature and viscosity ranges, so that warm drinks are not dispensed. Product temperature may be determined by temperature sensors and product viscosity is related to, and may be determined in accordance with, a measurement of current draw in amperes of each motor that rotates a scraper in an associated one of the barrels. In pull-down mode, the compressor 22 is turned on and the expansion valves 36 and 38 are controlled to meter refrigerant to the evaporators of the freeze barrels. When the compressor is turned on, it is contemplated that it initially be run at about 50% maximum capacity, and then be ramped up in speed from 50% maximum capacity to 100% capacity over a selected period of time, for example over 25 seconds, in which case compressor speed would be increased in increments of about 10% every 5 seconds. Product is not to be dispensed from a freeze barrel if its temperature is above or its viscosity is below predetermined ranges or specifications, so a lock for the dispense valve 82 can be provided to prevent dispensing of product from the valve when beverage temperature is above or beverage viscosity is below specification, or when the barrels are being defrosted. As the freeze barrels 44 and 48 are cooled, beverage product in the barrels will be brought to a desired temperature range, generally between about 24°-28° F. and the viscosity of the product, as determined by scraper motor current draw, will be brought to between a selected Lo Limit Value and Hi Limit Value. Once product in the barrels is brought to within the selected temperature and viscosity ranges, the compressor is turned off until further refrigeration is required.

The schedule for the speed of operation of the compressor advantageously is based upon demand for drinks dispensed, as represented by the on-time of the brixing valves 102, 84 and 104, 87, since it is the relatively warm beverage mixture delivered through the dispenser and into the barrels, to replace frozen beverage product dispensed from the barrels, that must be chilled and that places a cooling load on the refrigeration system 20. When no frozen beverages are being dispensed, barrel maintenance occurs, during which periods barrel refrigeration may be initiated if product viscosity drops to a cut-in value or product temperature increases to at least a selected upper temperature. To reduce beverage product temperature before delivery of the product to a freeze barrel, when a pair of brix valves 102, 84 and 104, 87 is actuated to deliver beverage product mixture to a freeze barrel, the pre-chiller expansion valve 40 is operated to cool the pre-chiller 52. Advantageously, pre-chilling is begun as soon as there is a call for the brix valves to open, since refrigeration of just the freeze barrels may be insufficient to meet cooling loads that are both high and sustained.

The chart of FIG. 7 shows how compressor speed may be based upon demand for drinks dispensed. For example, according to one contemplated control scheme, compressor speed is determined by whether the barrels 44 and 50, and the pre-chiller 52, are in pull down, product freezing or maintenance mode, as well as by the dispense rate of beverages.

The product freeze barrels 44 and 48 are automatically filled based upon internal barrel pressure. For example, when the cut in/cut out pressure sensor (e.g., the sensor 134 in FIG. 5) senses pressure within the freeze barrel 44 decreasing to about a 20 psi cut-in pressure, the water/syrup brix valves 102, 84 are opened to provide a water and syrup beverage product mixture through the pre-chiller 52 to the barrel, and a similar operation occurs in refilling the freeze barrel 48. During refilling of a freeze barrel, the electronic expansion valve 40 is opened, if and as necessary, to cool the pre-chiller, so that the beverage mixture is chilled before being introduced into the barrel. The brixing valves then remain open until internal freeze barrel pressure reaches about a 28 psi cut-out pressure, whereupon the brixing valves are closed. If necessary, all three evaporators 42, 46 and 50 can be cooled simultaneously to facilitate pre-chilling and freezing product in both barrels simultaneously, since the compressor 22 is selected to have sufficient capacity to handle such a maximum cooling load. In order that a non-flowing beverage mixture within the pre-chiller will not be frozen, the pre-chiller is not cooled by itself in the absence of cooling of at least one of the product freeze barrels 44 and 48. Upon the brixing valves closing and the temperature of the beverage product in the pre-chiller dropping to about 36° F., the expansion valve 40 for the pre-chiller is closed, although continued cooling of beverage product in the pre-chiller will continue for a limited time due to thermal storage capacity of the pre-chiller. Upon the temperature and viscosity of beverage product in each freeze barrel 44 and 48 being brought to within selected temperature and viscosity ranges, the compressor 22 is turned off.

If at a time when the compressor 22 is running there is little or no heat load imposed by the product barrels 44 and 48, or if product demand suddenly stops, there will very quickly be excess and unutilized compressor capacity. If the compressor were to continue running in that mode, the expansion valves 36 and 38 would dose down and suction pressure at the outlets from the evaporators 42 and 46 would drop to a very low value. The compressor would then pull down the temperature of product in the barrels and would have to be shut off to prevent excessive freezing of product in the barrels. To alleviate this potential problem, the capacity of the refrigeration system 20 is varied by varying the speed of the compressor, such that as cooling load demand drops, as may be measured by a reduction in the count in the Btuₜₒₜₐₗ counter of the controller, compressor speed is reduced in 5% increments, until 50% nominal speed is achieved. Advantageously, compressor speed should be reduced to 50% nominal speed before barrel product temperature and viscosity conditions are fully satisfied, or before compressor suction pressure (or saturated evaporator temperature) drops to a lower limit. Since cooling load demand is conveniently defined in terms the brixing valves 102, 84 and 104, 87 being actuated or opened, and therefore in terms of a call for beverage product, when demand for product decreases, cooling load demand of the freeze barrels decreases, and when demand for product increases, cooling load demand of the barrels increases. Monitoring actuations or openings and the durations of the actuations or openings of the pairs of brix valves 102, 84 and 104, 87 is, therefore, a convenient measure of cooling load demand, such that cooling loads may be considered to be high if the brixing valves are actuated more than 2 times per minute, and may be considered low the brixing valves are actuated less than 2 times per minute. It presently is contemplated that if actuation of a pair of brixing valves is less frequent than 1×16 oz drinks per minute, the compressor can be operated at 50% speed. When compressor speed is reduced and refrigeration cooling capacity is reduced, a saturated evaporator temperature of 4° F. will continue to cool product in a barrel, until both temperature and viscosity conditions of product in the barrel are satisfied, whereupon the compressor shuts off and the speed of the beater bar or scraper in the barrel may be reduced to half speed.

As seen from the chart of FIG. 8, a drink demand rate in excess of 1×16 oz drink per minute, as determined by actuation of the brixing valves 102, 84 and 104, 87, may be considered a period of medium to very high cooling load demand, requiring refrigeration of the freeze barrels 44 and 48, as well as of the pre-chiller 52, which is refrigerated whenever a pair of brixing valves is actuated. As mentioned, actuation of the brixing valves is monitored as a convenient measure of whether there is or is not a significant cooling load for the refrigeration system to satisfy, since the cooling load is based upon the number of Btu's required to chill and freeze the beverage components flowed from the brixing valves. If there is a significant load, all three evaporators, i.e., the freeze barrel evaporators 42 and 46 and the pre-chiller evaporator 50 will be used for cooling the beverage, refrigerant will be metered in controlled amounts to all three evaporators and the compressor will be operated at a speed appropriate to the flow rate of refrigerant through the expansion valves.

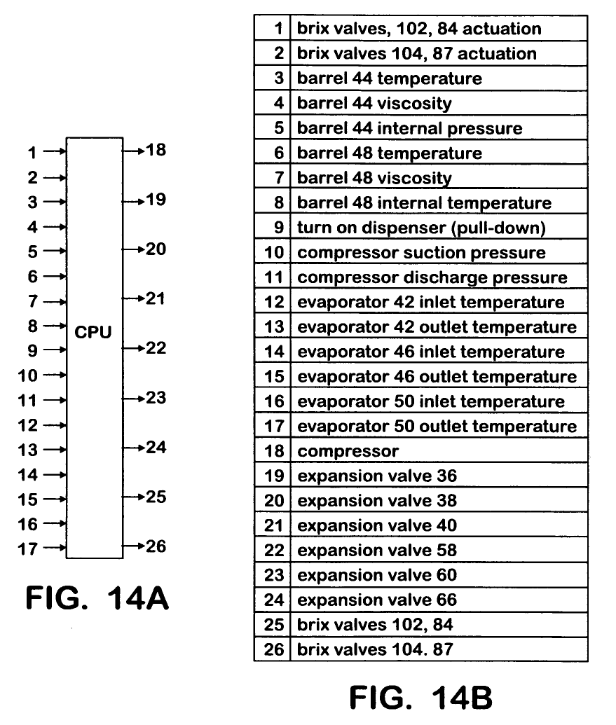

A dosed loop microprocessor, FIGS. 14A-14B, controls operation of the FCB dispenser and its refrigeration system 20. The microprocessor includes the Btuₜₒₜₐₗ counter, and receives measurements of refrigerant liquid/vapor temperatures at the inlets and outlets of the evaporators 42, 46 and 50. The microprocessor also receives other inputs from the FCB dispenser in accordance with control strategies that are to be implemented to enable a determination as to the state of the cooling demand. For example, since barrel refrigeration affects product temperature and product viscosity, and since as product viscosity goes up, product temperature goes down, it is contemplated that cooling capacity of the refrigeration system 20 be decreased by increasing an empirically derived set point for leaving evaporator superheat and drying out the evaporator coil to reduce the percentage of liquid phase, in accordance with the count in the Btuₜₒₜₐₗ counter. Also, based upon a pressure differential between compressor suction and discharge, it is contemplated that the expansion valves be pre-positioned to a selected setting, which setting can be in accordance with the count in the Btuₜₒₜₐₗ counter, and that microprocessor control begin once conditions have begun to stabilize either above or below a superheat set point. In addition, it is contemplated that as cooling load increases or decreases, as determined by the change in the count in the Btuₜₒₜₐₗ counter, the speed of the compressor be modulated proportionately to the change in cooling load. Also, once the cooling load drops below the modulating speed range of the compressor, continued modulation of the cooling capacity of the refrigeration system 20 may be accomplished by modulating the position of the expansion valves in accordance with the count in the Btuₜₒₜₐₗ counter, as determined by brixing valve actuation.

The pre-chiller 52 is operated whenever a pair of brixing valves 102, 84 and 104, 87 is actuated to chill the water and syrup mixture flowing to the freeze barrels 44 and 46. When the pre-chiller is operated, its expansion valve 40 is controlled so that the beverage mixture flowing through it is chilled to and exits at a temperature of about 40° F. When a beverage mixture ceases to flow through the pre-chiller upon closing of the brixing valves, the pre-chiller expansion valve 40 is closed. If the refrigerant flow path through the pre-chill evaporator 50 is an upward flow path, the evaporator can be treated as a flooded or batch-type evaporator whenever a pair of brix valves is activated, such that its expansion valve 40 is operated so that refrigerant liquid is flowed into the bottom of the evaporator. It is desirable to eliminate refrigerant liquid flow out of the top of the evaporator and also to limit the extent of cooling of the pre-chiller by the evaporator to reduce the risk of freezing the beverage mixture within the pre-chiller. For that purpose, it is contemplated that the expansion valve 40 be controlled such that there is a time dispense of refrigerant liquid into the lower end of the evaporator, with the time based upon the amount of refrigerant liquid required to cool a prescribed volume of beverage mixture flowing through the pre-chiller. The time dispense and the volume of refrigerant liquid introduced into the lower end of the evaporator may be controlled as a function of each of the temperature of the beverage mixture requiring pre-cooling, the volume of the beverage mixture as determined by the time that the brixing valves are actuated, and the speed of the compressor 22, which may be varied to control the flow rate of refrigerant into the evaporator.

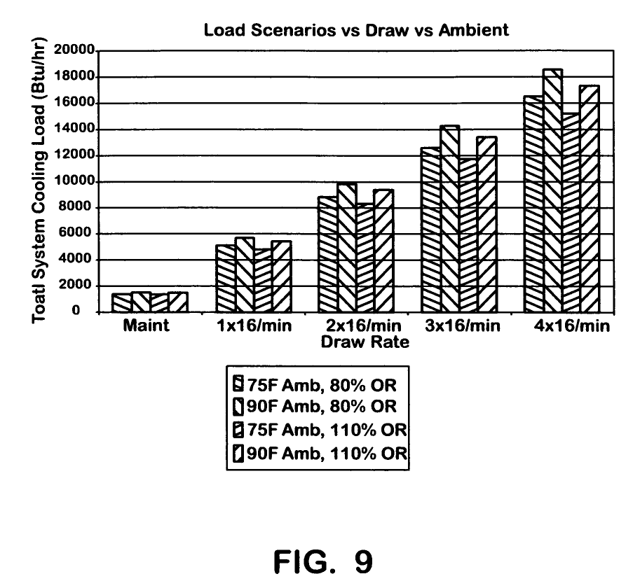

The chart of FIG. 9 shows a typical cooling load profile placed on the refrigeration system 20 by the FCB dispenser 80, where in the legend box to the right of the chart “OR” stands for overrun, which is the amount of beverage in a cup attributable to carbonation. In responding to and satisfying the cooling load, the microprocessor controls operation of the refrigeration system, such that the settings of the expansion valves 36, 38 and 40 for the freeze barrel and pre-chiller evaporators 42, 46 and 50, together with the speed of operation of the refrigeration system compressor 22, are in accordance with the count entered into the Btuₜₒₜₐₗ counter. In essence, the total Btu's required to satisfy the cooling load, which are determined from the time of actuation of the brixing valves and the ambient temperature of the beverage mixture flowed through valves, is entered into and increments the count in the Btuₜₒₜₐₗ counter. The microprocessor then operates the refrigeration system 20 to provide cooling to the FCB dispenser, in a manner in accordance with the instantaneous count in the Btuₜₒₜₐₗ counter and that reduces the count to zero at a determined rate.

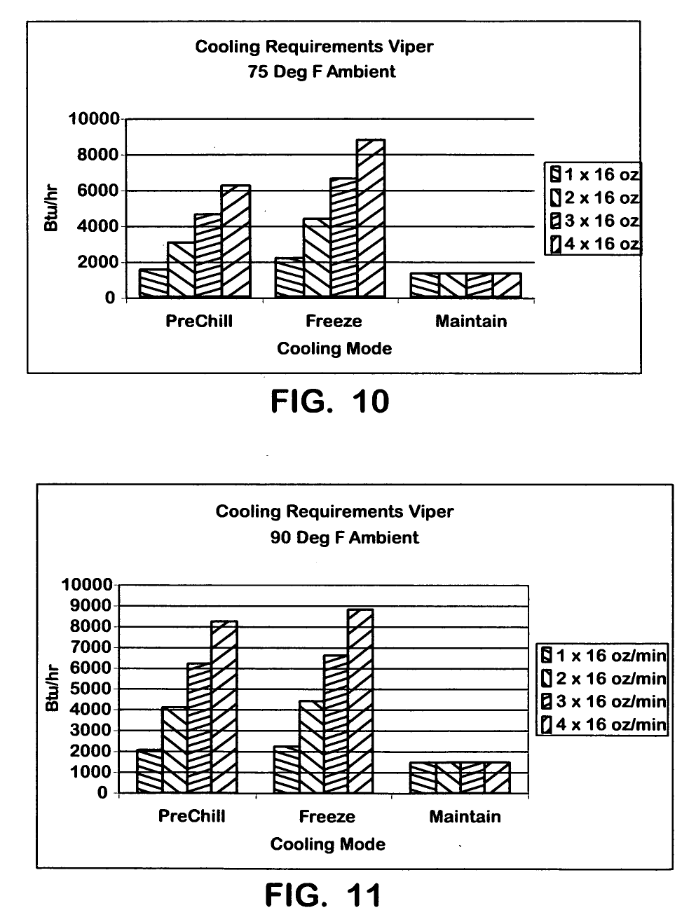

The chart of FIG. 10 illustrates cooling load requirements for the beverage product cooling modes of pre-chilling, freezing and maintenance, at an ambient temperature of 75° F., for various drink draw rates. The chart of FIG. 11 is similar to that of FIG. 10, except that cooling load requirements are shown for an ambient temperature of 90° F.

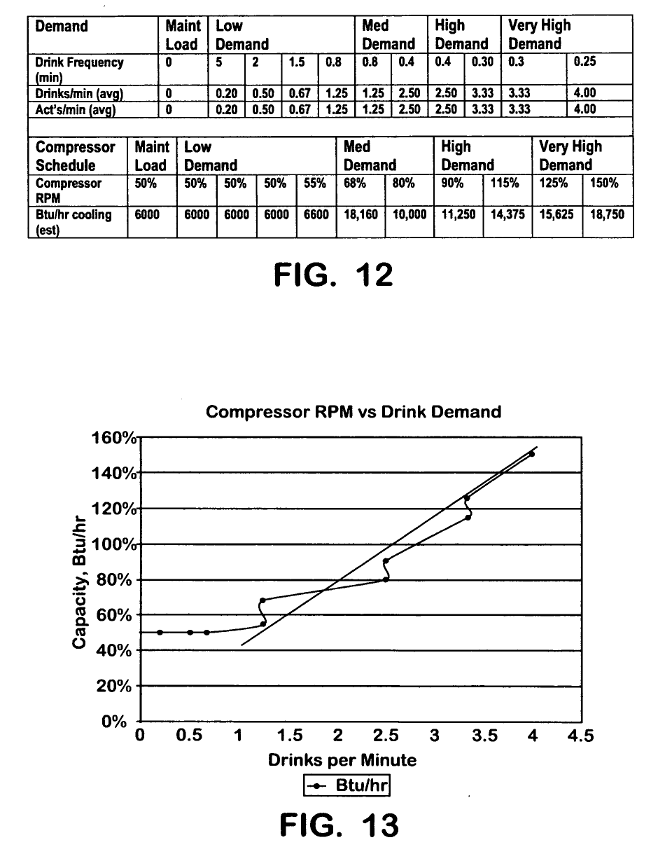

The table of FIG. 12 shows, for a refrigeration system 20 having a maximum capacity of 18,750 Btu/hr, the speed of operation of the variable speed compressor 22 as a function of cooling load demand, as well as the relationship between cooling load demand, drink frequency as represented by actuations/minute of the pairs of brix valves, and Btu/hr output of the refrigeration system in terms of the speed of operation of the compressor.

The graph of FIG. 13 shows the cooling load requirements of the refrigeration system 20 in relation to beverages served per minute, and in particular the manner in which cooling load requirements significantly increase when the demand for drinks served increases to at least medium demand (see FIG. 12).

The refrigeration system of the invention has been described in connection with the manufacture of frozen carbonated beverages. However, as is apparent to those of skill in the art, the refrigeration system may also advantageously be used in the manufacture of other types of frozen food products, such as in making ice cream, yoghurt, alcoholic drinks or other suitable creamy and/or slushy frozen food products.

While embodiments of the invention have been described in detail, various modifications and other embodiments thereof may be devised by one skilled in the art without departing from the spirit and scope of the invention, as defined by the appended claims.

1-2. (canceled)

3. A frozen product dispenser, comprising;
at least one product freeze barrel for freezing product therein;
means for dispensing frozen product from said at least one barrel;
means for delivering product into said at least one barrel to replace frozen product dispensed from said at least one barrel;
a variable cooling capacity refrigeration system for chilling said at least one barrel to freeze product therein; and
means for controlling said refrigeration system to have a cooling capacity that is in accordance with the chilling required by said at least one barrel in order to freeze product in said at least one barrel, so that said refrigeration system is able to efficiently respond to dynamically changing cooling load requirements of said at least one freeze barrel.

4. A frozen product dispenser as in claim 3, wherein said at least one product freeze barrel comprises two product freeze barrels and said refrigeration system includes a variable capacity compressor, two evaporators each heat transfer coupled to an associated one of said barrels, and two expansion valves each for metering a flow of refrigerant from said compressor to an associated one of said evaporators to chill said freeze barrels.

5. A frozen product dispenser as in claim 4, wherein said means for controlling said refrigeration system controls said expansion valves to meter refrigerant to each evaporator at a rate commensurate with the cooling load requirement of the associated freeze barrel, and controls the speed of operation of said compressor to flow to said expansion valves a refrigerant mass flow that is commensurate with that being metered through said expansion valves.

6. A frozen product dispenser as in claim 5, wherein in response to said delivering means delivering product into a freeze barrel, said means for controlling determines the cooling load requirement of the freeze barrel and adjusts the cooling capacity of said refrigeration system in accordance with such cooling load requirement.

7. A frozen product dispenser as in claim 5, wherein in response to said delivering means not delivering product into a freeze barrel for at least a selected period of time, said control means controls said refrigeration system to either be off or to have a relatively low cooling capacity.

8. A frozen product dispenser as in claim 5, wherein said control means controls said refrigeration system to have a cooling capacity that follows dynamically changing cooling load requirements of said freeze barrels.

9. A frozen product dispenser as in claim 4, including a product pre-chiller, said delivering means flowing product through said pre-chiller before the product is delivered into said freeze barrels, said refrigeration system including a third evaporator heat transfer coupled to said pre-chiller and a third expansion valve for metering a flow of refrigerant from said compressor to said third evaporator to chill said pre-chiller and thereby chill product flowed therethrough.

10. A frozen product dispenser as in claim 5, including means responsive to delivery of product into a freeze barrel for determining the cooling to be provided by said refrigeration system to the barrel to properly chill product in the barrel, said controlling means being responsive to said determining means to control said refrigeration system to have a cooling capacity in accordance with the cooling that must be provided to the barrel.

11. A frozen product dispenser as in claim 10, wherein said means for determining includes means for sensing the quantity of product delivered by said delivering means to a freeze barrel and for ascertaining the number of Btu's of cooling that are to be provided to the freeze barrel by said refrigeration system to chill product in the freeze barrel, said means for controlling being responsive to said ascertaining means to control said refrigeration to have a cooling capacity in accordance with the number of cooling Btu's that are to be provided to the barrel.

12. A frozen product dispenser as in claim 11, including a counter, means responsive to said ascertaining means for incrementing the count in said counter by the number of Btu's that must be provided to the freeze barrel by said refrigeration system to freeze product delivered into the barrel, means for decrementing the count in said counter by the number of Btu's of cooling provided by said refrigeration system to the barrel, and means for sensing the viscosity of product in the barrel, said controlling means controlling said refrigeration system to decrease the rate of cooling of the barrel as the count in said counter is decremented toward zero and to terminate cooling of the barrel upon the sensed viscosity of product in the barrel increasing to a selected value.

13. A frozen product dispenser as in claim 10, including a counter, means responsive to the time of operation of said delivering means to deliver product to a freeze barrel for incrementing a count in said counter by the number of Btu's of cooling that must be provided to the barrel by said refrigeration system to freeze product in the barrel, means for decrementing the count in said counter by the number of Btu's of cooling provided by said refrigeration system to the barrel, whereby the count in said counter is indicative of the cooling load demand being placed on said refrigeration system by the barrel, and means for sensing whether the count in said counter is increasing or decreasing, said controlling means increasing the cooling capacity of said refrigeration in response to said sensing means sensing that the count in said counter is increasing and decreasing the cooling capacity of said refrigeration in response to said sensing means sensing that the count in said counter is decreasing.

14. A frozen product dispenser as in claim 13, wherein said controlling means, in response to said sensing means sensing that the count in said counter is increasing, incrementally increases said refrigeration system cooling capacity by incrementally further opening the expansion valve associated with the freeze barrel being chilled and by incrementally increasing the speed of operation of said compressor, and in response to said sensing means sensing that the count in said counter is decreasing, incrementally decreases said refrigeration system cooling capacity by incrementally closing the expansion valve associated with the freeze barrel being chilled and by incrementally decreasing the speed of operation of said compressor.

15. A frozen product dispenser as in claim 10, wherein said controlling means is responsive to the time that said delivering means delivers product into a freeze barrel during a given period of time to variably control the output capacity of said refrigeration system in accordance with whether said refrigeration system is to meet a maintenance, low, medium, high or very high cooling load of the freeze barrel.

16. A frozen product dispenser as in claim 9 wherein, in response to operation of said delivery means to flow product through said pre-chiller and into a freeze barrel, said control means controls said refrigeration system to operate said compressor and open said third expansion valve to chill said pre-chiller and thereby chill product flowed through said pre-chiller.

17. A frozen product dispenser as in claim 13, wherein said control means is responsive to incremental increases and decreases in the count in said counter to respectively incrementally increase and decrease the cooling capacity of said refrigeration system.

18. A frozen product dispenser as in claim 5, wherein said control system incrementally increases and decreases the cooling capacity of said refrigeration system by varying the speed of operation of said compressor and modulating the flow rate of refrigerant through said expansion valves.

19. A method of operating a frozen product dispenser, said method comprising the steps of:
dispensing frozen product from at least one product freeze barrel of the frozen product dispenser;
delivering product into the at least one barrel to replace frozen product dispensed from the at least one barrel;
using a variable cooling capacity refrigeration system to chill the at least one barrel to freeze product therein; and
controlling the refrigeration system to have a cooling capacity that is in accordance with the chilling required by the at least one barrel in order to freeze product in the at least one barrel, so that the refrigeration system has a variable cooling capacity and efficiently responds to dynamic variations in cooling load requirements of the at least one freeze barrel.

20. A method as in claim 19, wherein the at least one product freeze barrel comprises two product freeze barrels and the refrigeration system includes a variable speed compressor, two evaporators each heat transfer coupled to an associated one of the barrels and two expansion valves each for metering a flow of refrigerant from the compressor to an associated one of the evaporators to chill the freeze barrels, and said controlling step controls the speed of the compressor and the refrigerant metering rates of the expansion valves to control the cooling capacity of the refrigeration system.

21. A method as in claim 20, wherein said controlling controls the refrigerant metering rate of the expansion valves to meter refrigerant to each evaporator at a rate commensurate with the cooling load requirement the freeze barrel heat transfer coupled to each evaporator, and controls the speed of operation of the compressor to flow to the expansion valves a refrigerant mass flow that is commensurate with that being metered through the expansion valves.

22. A method as in claim 21, including the step, performed in response to delivery of product into a freeze barrel, of determining the cooling load requirement of the barrel in order to freeze product therein, said controlling step being responsive to said determining step to adjust the cooling capacity of the refrigeration system in accordance with the cooling load requirement of the barrel.

23. A method as in claim 21 wherein, in response to said delivering step not being performed for at least a selected period of time, said controlling step controls the refrigeration system to either be off or to have a relatively low cooling capacity.

24. A method as in claim 21, wherein said controlling step controls the refrigeration system to have a cooling capacity that follows dynamically changing cooling load requirements of the freeze barrels.

25. A method as in claim 20, wherein the dispenser includes a product pre-chiller and the refrigeration system includes a third evaporator heat transfer coupled to the pre-chiller and a third expansion valve for metering a flow of refrigerant from the compressor to the third evaporator to chill the pre-chiller, said delivering step flowing through the pre-chiller for being chilled before the product is delivered into a barrel.

26. A method as in claim 21, including the step, in response to said delivering step delivering product into a freeze barrel, of determining the cooling to be provided by the refrigeration system to the barrel to chill product in the barrel, said controlling step being responsive to said determining step to control the refrigeration system to have a cooling capacity in accordance with the cooling to be provided to the barrel.

27. A method as in claim 26, said determining step comprising the steps of sensing the quantity of product delivered to a freeze barrel, and ascertaining the number of cooling Btu's that must be provided to the barrel by the refrigeration system to chill product in the barrel, said controlling step being responsive to said ascertaining step to operate the refrigeration to have a cooling capacity in accordance with the number of cooling Btu's that are to be provided to the barrel.

28. A method as in claim 21, including the steps, performed in response to performance of said delivering step delivering product into a freeze barrel, of sensing the quantity of product delivered into the barrel, ascertaining the number of cooling Btu's that must be provided by the refrigeration system to the barrel to chill product in the barrel, incrementing a count in a counter by the number of Btu's ascertained by said ascertaining step, the count in the counter being indicative of the cooling load demand being placed on the refrigeration system by the freeze barrel and said controlling step being responsive to the count in the counter to operate the refrigeration system at a cooling capacity in accordance with the value of the count, decrementing the count in the counter by the number of cooling Btu's provided by the refrigeration system to the barrel, and sensing the viscosity of product in the barrel, said controlling step controlling the refrigeration system to decrease the rate of cooling of the barrel as the count in the counter is decremented toward zero and to terminate cooling of the barrel upon the sensed viscosity of product in the barrel increasing to a selected value.

29. A method as in claim 28, including the step of detecting whether the count in the counter is increasing or decreasing, said controlling step being responsive to said detecting step to increase the cooling capacity of the refrigeration system if the count in the counter is increasing and to decrease the cooling capacity of the refrigeration system if the count in the counter is decreasing.

30. A method in claim 29, wherein for a freeze barrel being chilled said controlling step is responsive to said detecting step detecting that the count in the counter is increasing to increases the refrigeration system cooling capacity by incrementally opening the expansion valve for the barrel and incrementally increasing the speed of operation of the compressor, and is responsive to said detecting step detecting that the count in the counter is decreasing to decrease the refrigeration system cooling capacity by incrementally dosing the expansion valve for the barrel and incrementally decreasing the speed of operation of the compressor.

31. A method as in claim 26, wherein said controlling step is responsive to the time for which said delivering step delivers product to a freeze barrel during a given period of time to control the cooling capacity of the refrigeration system to be within a range from a very low to a very high cooling capacity.

32. A method as in claim 25 wherein, in response to performance of said delivering step to flow product through the pre-chiller and into a freeze barrel, said controlling step controls the refrigeration system to operate the compressor and open the third expansion valve to chill the pre-chiller and thereby chill product flowed through the pre-chiller.

33. A method as in claim 29, wherein said controlling step is responsive to incremental increases and decreases in the count in the counter to respectively incrementally increase and decrease the cooling capacity of the refrigeration system.

34. A frozen method as in claim 21, wherein said controlling step controls the refrigeration system to incrementally increases and decreases the cooling capacity of the refrigeration system by varying the speed of operation of the compressor and modulating the flow rate of refrigerant through the expansion valves.
